(19) United States
(12) Patent Application Publication
(10) Pub. No.: US 2005/0260418 A1
(43) Pub. Date: Nov. 24, 2005

(54) Laminated windows that are resistant to extreme heat or fire conditions

(76) Inventors: Phillip Sydney Davies, North Curl Curl (AU); Christopher John Barker, Brighton (AU)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/045,744

(22) Filed: Jan. 27, 2005

Related U.S. Application Data
(60) Provisional application No. 60/539,862, filed on Jan. 28, 2004.

(51) Int. Cl. B32B 17/06

(52) U.S. Cl. 428/426

(57) ABSTRACT

The present invention is a laminated glass window that is resistant to extreme heat, or fire as the heat source, comprising a coating on the surface of the glass nearest the heat source.

This application claims the benefit of U.S. Provisional Application No. 60/539,862, filed Jan. 28, 2004.

### BACKGROUND OF THE INVENTION

The performance of ordinary building materials exposed to extreme conditions of heat and/or fire is of interest. Particularly in areas that are at higher than normal risk for exposure to forest fires, building materials are sought which can withstand, or at least be resistant to, extreme heat and/or fire.

Most buildings have windows for allowing in light or ventilate the building. Windows, however, can be an entry port for fire that originates outside of the building. Ordinary window glass, for example, is known to explode in a fire. Glass can also melt, decompose, or simply crack and crumble away, leaving open holes to the building where the window had once been. As a result hot embers can be drawn into a building where a fire can be ignited inside, leaving people, property, and the structural integrity of the building itself in jeopardy.

Various regions have developed building codes which require that the building materials pass certain performance criteria with regard to their fire-resistant properties.

Use of laminated glass products in buildings is a common practice due to the increased sense of safety and security against window breakage provided by laminated glass products, yet the performance of laminated glass in extreme heat conditions can be problematical.

It can be desirable to have windows which resist giving way or exploding when exposed to extreme heat or fire, as may happen in a forest fire for example. In particular, it can be desirable to have laminated glass windows that can pass performance criteria in tests of fire resistance.

### SUMMARY OF THE INVENTION

In one aspect, the present invention is a fire-resistant laminated glass window comprising on the surface of the glass nearest the heat source a pyrolytic coating.

In another aspect the present invention is a fire-resistant laminated glass window comprising an interlayer, wherein the interlayer does not include a plasticizer.

In another aspect, the present invention is a fire-resistant laminated glass window comprising an interlayer, wherein the interlayer comprises or consists essentially of a plasticizer having low volatility.

### DETAILED DESCRIPTION OF THE INVENTION

In one embodiment, the present invention is a single pane (as differentiated from an insulated glass unit having an air space between two glass panes) laminated glass glazing unit that has improved resistance to heat or extreme temperature conditions that may be prevalent in a fire. A laminated glazing of the present invention can be conventional in all respects, except that a glazing of the present invention comprises a coating of a low energy reflective material on the surface that would be exposed to a fire external to the building housing the glazing unit. This surface is hereinafter referred to as surface #1. A low energy (Low-E) coating of the present invention is a metallic coating that is deposited on the surface of the glass by conventional methods, known to one of ordinary skill in the art of glass manufacture. For example, the Low-E coating can be a so-called “soft coating”, which is applied by a sputtering method wherein the coating is applied to the surface of the glass after the glass substrate has been manufactured. Alternatively, the Low-E coating can be a pyrolytic coating, also referred to herein as a hard coating, that is applied to the glass at the same time as the glass is being manufactured. A pyrolytic Low-E coating is bonded more strongly to the surface of the glass than is a soft coating. Either type of coating can be useful in the practice of the present invention.

In a conventional Low-E laminated glazing product the coating is applied to a surface that faces the interior of the building for various reasons, such as the #4 surface in a single pane laminated glass unit. However, it has surprisingly been found that by coating the #1 surface with a Low-E coating the performance of a glazing product exposed to extreme heat conditions, such as in a fire, can be significantly improved. Increasingly, building standards are requiring standard performance levels for building materials used in construction of buildings and the like. For example, it has been proposed in Australia that windows should be able to remain intact for a set period (for example, at least 3 minutes) upon exposure to high levels of radiation (for example, 29 kW per square meter of glass). Ordinary single pane glass does not pass this standard. Conventional laminated glass does not pass this standard.

Coating a laminated glass product with a low-E coating on the exterior surface distinguishes such coated products from conventional glazing products, or low-E coated products having the coating on an interior surface, in the test. A further improvement in the performance of a laminated glass product can be in the selection of the components of the interlayer. For example, in a plasticized interlayer product such as polyvinylbutyral, plasticization with a plasticizer having a relatively low volatility can be advantageous. For example, use of tetraethylene glycol 2-heptanoate (4G7) as plasticizer is preferred in the practice of the present invention over the use of triethylene glycol 2-octanoate (3 GO) because 4G7 has lower volatility than 3GO.

Any conventional interlayer material that is known to be useful in the production of laminated glass products can be used in the practice of the present invention. For example, polyvinylbutyral (PVB), polyurethane (PUR), polyvinylchloride (PVC), polyesters such as polyethylene glycol terephthalate (PET), copolymers of ethylene and (meth)acrylic acid (and ionomers derived therefrom) such as those obtained from E.I. DuPont de Nemours and Company under the tradename Surlyn®, can be useful in the practice of the present invention.

A laminate can be constructed using conventional lamination techniques. One of ordinary skill in the glass lamination art would know how to make a laminated glass unit useful for the practice of the present invention.

A window can be place into a building using conventional construction techniques. One of ordinary skill in the construction industry would know how to place a window into a building frame.

In another embodiment, the present invention is an insulated glass glazing unit having a low-E coating on either surface #1 or surface #3, or on both glass surfaces. Glass surface #3 is the glass surface which is the first glass surface encountered on the interior of the insulated glass unit, and which faces the exterior of the glazing unit (away from the laminated surface of glass). Put another way, an insulated glass unit of the present invention can have the same construction as a single pane construction with the additional feature of another non-laminated pane of glass exterior to the coated surface, with an intervening air space between the two glass panes. The non-laminated pane of glass can have a low-E coating on its exterior surface (surface #1 of the insulated glass), or not. If surface #1 is not coated, surface #3 must be coated. In the event that surface #1 is not coated, the exterior single pane of glass very quickly gives way when exposed to extreme conditions of heat radiation, thereby exposing surface #3 to the heat radiation. In the event that surface #3 is coated, the insulated glass unit would then have the same performance as the single pane laminated glass unit.

### EXAMPLES

The following Examples and Comparative Example are intended to be illustrative of the present invention, and are not intended in any way to limit the scope of the present invention.

### Example 1

A glass laminate was prepared having a construction as follows: 3 mm of low-E coated glass/0.76 mm PVB/3 mm clear.

### Example 2

A glass laminate was prepared having a construction as follows: 3 mm of low-E coated glass/1.52 mm ionoplast sheet/3 mm uncoated glass.

### Example 3 (Comparative)

An insulated glass (IG) unit was prepared having a construction as follows: 6.38 mm uncoated glass/6 mm Air Space/6.38 mm uncoated glass.

### Example 4

An insulated glass unit was prepared having a construction as follows: 6.38 mm of low-E coated glass/6 mm Air Space/6.38 mm uncoated glass.

### Example 5

A glass laminate was prepared having a construction as follows: 3 mm of low-E coated glass/0.38 mm B51/3 mm uncoated glass.

1. A fire-resistant single pane laminated glass window comprising at least one pane of glass adhered on one surface to an interlayer, wherein the glass comprises a low-E coating on the surface of the glass that is not adhered to the interlayer.

2. The glass window of claim 1 wherein the interlayer does not comprise a plasticizer.

3. The glass window of claim 1 wherein the interlayer comprises or consists essentially of a plasticizer having low volatility.
